(19) United States
(12) Patent Application Publication
(10) Pub. No.: US 2017/0165904 A1
(43) Pub. Date: Jun. 15, 2017

(54) COMPOSITE STEEL

(71) Applicant: AK Steel Properties, Inc., West Chester, OH (US)

(72) Inventors: Robert James Comstock, JR., Trenton, OH (US); Jeffrey Douglas Alder, Eaton, OH (US)

(21) Appl. No.: 15/374,536

(22) Filed: Dec. 9, 2016

Related U.S. Application Data
(60) Provisional application No. 62/266,314, filed on Dec. 11, 2015.

(51) Int. Cl. B29C 65/48; B29C 65/02; B23K 31/02

(52) U.S. Cl. CPC B29C 65/48; B23K 31/02; B29C 65/02; B23K 2203/172

(57) ABSTRACT

To improve the stiffness of a thin single layer or mono-sheet of steel, a composite steel comprising at least two outer steel layers separated with a spacer. Spacer materials can include any metal less dense than steel, or a polymer or resin, optionally comprising a carbon or glass fiber, or Kevlar material. Such a composite steel can yield a higher stiffness than a mono-sheet of steel having the same total sheet thickness. For instance, moving the steel material away from the neutral axis with the spacer can increase the strain on bending to provide a high strength composite steel that maintains stiffness while also providing desirable weight savings.

### PRIORITY

This application claims priority to U.S. Provisional Application Ser. No. 62/266,314, entitled COMPOSITE STEEL filed on Dec. 11, 2015, the disclosure of which is incorporated by reference herein.

### BACKGROUND

High strength steels are typically used in the automotive industry for vehicle structural parts. In some instances, increasing the strength of the steel has allowed the gauge of the steel to be reduced to provide for weight savings of the material. Such gauge reduction in the automotive structural parts may sacrifice the stiffness of the material. Thus, there remains a need for a structural material that maintains stiffness while also allowing for use of a lighter gauge steel.

### SUMMARY

To improve the stiffness of a thin sheet, a composite steel sheet comprises two or more sheets steel that may be separated with at least one spacer. Spacer materials can include lighter weight metals, or a polymer or resin, with or without a filler that can include carbon fiber, glass fiber, or Kevlar material. Such a composite steel sheet can yield a higher stiffness than a mono-sheet (or single layer) of steel having the same. For instance, on bending, low strains can occur at sheet mid-thickness, or a neutral axis. Moving the steel material away from the neutral axis with the spacer can increase the strain on bending to provide a high strength composite steel that maintains stiffness while also providing the desired weight savings.

### DESCRIPTION OF THE FIGURES

It is believed that the present invention will be better understood from the following description of certain examples taken in conjunction with the accompanying drawings, in which like reference numerals identify like elements.

FIG. 1 depicts a partial cross-sectional view of an embodiment of a composite steel.

FIG. 2 depicts a top perspective view of a rail formed from a mono-sheet of steel.

FIG. 3a depicts a partial cross-sectional view of the rail of FIG. 2.

FIG. 3b depicts a partial cross-sectional view of another embodiment of a rail formed from a composite steel.

FIG. 4 shows a bending load-displacement curve for a steel strip with a thickness of 0.059 inches, a steel strip with a thickness of 0.079 inches, and a polymer composite steel strip.

FIG. 5 shows a bending load-displacement curve for a steel strip with a thickness of 0.079 inches, a polymer composite steel strip, and a carbon fiber composite steel strip.

The drawings are not intended to be limiting in any way, and it is contemplated that various embodiments of the present disclosure may be carried out in a variety of other ways, including those not necessarily depicted in the drawings. The accompanying drawings incorporated in and forming a part of the specification illustrate several aspects of the present disclosure, and together with the descriptions serve to explain the principles and concepts of the present disclosure; it being understood, however, that the present disclosure is not limited to the precise arrangements shown.

### DETAILED DESCRIPTION

The following description and embodiments of the present disclosure should not be used to limit the scope of the present disclosure. Other examples, features, aspects, embodiments, and advantages of the present disclosure will become apparent to those skilled in the art from the following description. As will be realized, the present disclosure may contemplate alternate embodiments than those exemplary embodiments specifically discussed herein without departing from the scope of the present disclosure. Accordingly, the drawings and descriptions should be regarded as illustrative in nature and not restrictive.

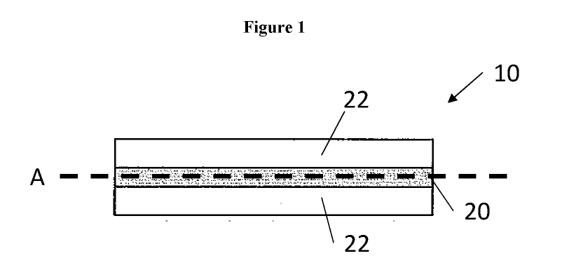

A composite steel comprises at least one spacer separating two or more outer steel layers. Such a composite steel can maintain the high strength and stiffness of a mono-steel, while also providing desirable weight savings. One embodiment of a composite steel sheet (10) is shown in FIG. 1. As illustrated, the outer steel layers (22) are separated by a bonded spacer (20) that provides good shear strength between the steel and the spacer such that the outer steel layers (22) maintain strength, while the spacer (20) can have a low density to reduce weight while allowing the steel to maintain sufficient stiffness. The spacer separates the outer steel layers from the neutral axis (zero strain) (A) on bending if the spacer and outer steel layers are sufficiently bonded such that sliding between the steel and spacer material does not occur on bending.

While sheet steels of any composition may be used in this composite steel, high strength, or advanced high strength steels are most advantageous. The higher tensile strengths of these steels allow the thickness of finished components to be reduced while maintaining stiffness. Stainless steels, that offer corrosion resistance, may also be used in the composite. The outer steel layers of the composite steel may comprise the same type of steel, or they may comprise different types of steel. Similarly, the two or more outer steel layers may each have the same thickness or they may each have a different thickness.

The spacer (20) can be made from any material that is lighter than the outer steel layers. It can comprise light weight metals including magnesium, aluminum, or their respective alloys. It may be made from various polymers or resins, that may further comprise carbon or glass fiber, Kevlar, etc. The thickness of the spacer (20) may range between about 5% and 90% of the total thickness of the composite, including any intervals therebetween (10).

The separation between outer steel sheets (22) provided by the spacer (20) can increase stiffness. For instance, a composite steel with a top and bottom steel thickness of 0.5 mm each, totaling 1.0 mm of steel thickness, can yield higher stiffness than a mono-sheet of steel having the same total sheet thickness of 1.0 mm. On bending, low strains occur at sheet mid-thickness, or neutral axis (A). Stiffness decreases as the volume of material away from the neutral axis decreases. Accordingly, moving material away from the neutral axis increases the strain on bending.

As shown in FIG. 1, the composite steel (10) may be prepared by interleaving the outer steel layers (22) with the spacer material (20) such that there is a spacer between each two outer steel layers. Before further use of the resulting composite steel, the outer steel layers (22) may be bonded to the inner spacer material (20). Such bonding may be formed by applying a wide variety of adhesive materials between the outer steel layer and the spacer material. Rather than a separate adhesive material, in some embodiments, the spacer material, such as a polymer or a resin, may able to bond to the outer steel layers without the use of additional adhesive material. High strength bonds between the outer steel layers (22) and the inner spacing material (20) may be used to transfer bending stress to the outer steel layers (22) and maintain stiffness.

Once the composite sheet is fabricated, it can be used to form parts for use in applications such as automotive. To improve forming of such parts, the steel sheets (22) and the spacer (20) may be allowed to slide relative to one another during forming. In this instance, the adhesive if present, or the resin, may not fully set until after the part is formed, allowing relative sliding between the two outer steel layers. This will keep the strain in each of the outer steel layers to a minimum during the forming process. The interfacial bond between the spacer and the outer steel layers can be developed after the part forming process, for example by supplying heat, or some other curing method, to improve part stiffness. Such heating can occur during the forming process, such as by use of a heated press, or after forming in a subsequent operation, such as in a painting step or in a dedicated curing process.

Still other methods for making the composite steel (10) will be apparent to one with ordinary skill in the art in view of the teachings herein.

By using such a composite steel (10), it is also possible to use differing metals and steels in the composite structure to tailor properties such as corrosion resistance or aesthetics. For instance, a corrosion resistant steel layer can be provided on one surface, while a lesser expensive backing steel can be used on the opposing surface for added strength. For example, once could use a stainless steel outer layer on one side of the composite steel and a carbon steel outer layer on the other side. Increasing the stiffness with the composite steel (10) may also decrease noise due to vibration in automotive applications.

Still other applications of the composite steel (10) will be apparent to one with ordinary skill in the art in view of the teachings herein.

### Example 1

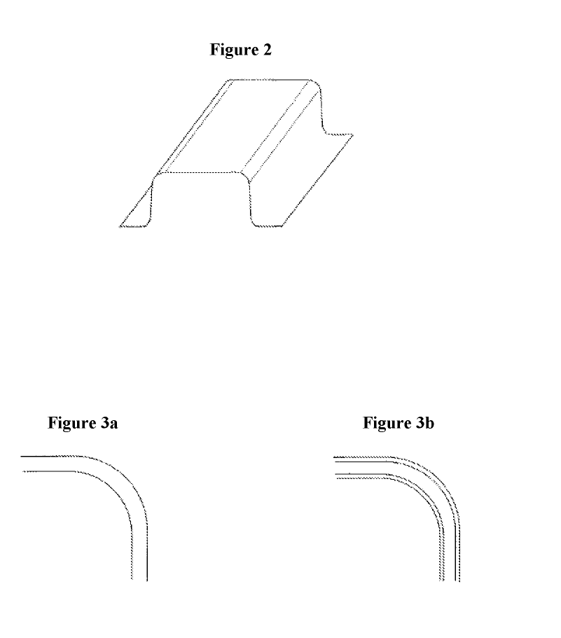

The performance of a composite steel sheet was compared with mono-steel sheets using a structural rail as shown in FIG. 2. The mono-steel sheet, shown in FIG. 3a, is a single DP600 sheet having a thickness of about 2 mm. The composite steel, shown in FIG. 3b, includes two DP980 steel sheets separated by a spacer. Each DP980 steel sheet has a thickness of about 0.61 mm. The tensile strength of the DP600 steel sheet is about 600 MPa. The tensile load carrying capability in a 1 mm width of DP600 rail is therefore 1200 N. The tensile strength of the DP980 steel sheet is about 980 MPa. The tensile load carrying capability in a 1 mm width of two DP980 steel sheets is also approximately 1200 N. Accordingly, two sheets of 0.61 mm thick DP980 material are equivalent to the tensile load carrying capability over a 1 mm length of DP600 rail.

The thickness of the spacer determines the stiffness of the DP980 frame. Applying a torque of 0.134 Nm per mm of length to a 2 mm DP600 steel sheet yields a surface strain of about 0.1%. This strain results in a 1 m radius of curvature on the steel. The torque required to impose the same 1 m radius of curvature on a single 1.22 mm thick (2×0.61 mm) DP980 steel sheet is only 0.031 Nm per mm of length. This is less than 25% of the thicker DP600 sheet.

Accordingly, inserting a spacer between two 0.61 mm thick DP980 sheets increases the stiffness by moving steel away from the neutral axis, thereby requiring more elastic strain with the imposed 1 m radius of curvature. Separating the two 0.61 mm sheets by 0.82 mm yields an identical torque requirement to bend to a 1 m radius of curvature. Therefore, the spacer between the two DP980 sheets equals 0.82 mm to obtain the same stiffness as the thicker DP600 part. The steel in the composite is reduced from 2 mm thick to 1.22 mm thick (2×0.61 mm) thick, a 0.78 mm reduction, or about 39%. Therefore, the weight of the rail may also be decreased by about 39%.

### Example 2

Two sheets of 18 Cr-Cb™ steel were bonded on each side of a polymer using an epoxy resin impregnated into a fiber glass matrix (the polymer) to form the composite steel. The composite was allowed to cure while sitting with a small load applied to the structure. Each steel sheet had a thickness of about 0.018 inches. The composite was then compared to 18 Cr-Cb mono-steel sheets having a thickness of about 0.059 inches and a thickness of about 0.079 inches. Samples were sheared to 2 inches by 6 inches. The 18 Cr-Cb 0.059 inch thick mono-steel sheet had a weight of about 88 grams. The 18 Cr-Cb 0.079 inch thick mono-steel sheet has a weight of about 120 grams. The composite steel had a weight of about 72 grams, which was about 40% lighter than the 0.079-inch-thick steel sheet.

A bending load was applied to each sample in a three-point bend test. Each sample was centered across a 4 inch die with a 0.75 inch die radius. A centered punch having a 12 mm radius was loaded against each sample at a rate of 1.0 inches per minute. The bending load was measured as a function of punch displacement.

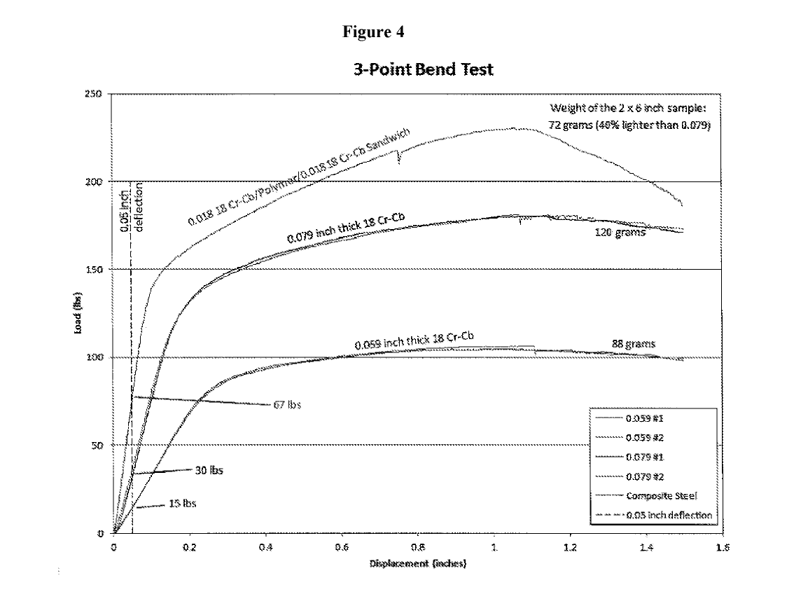

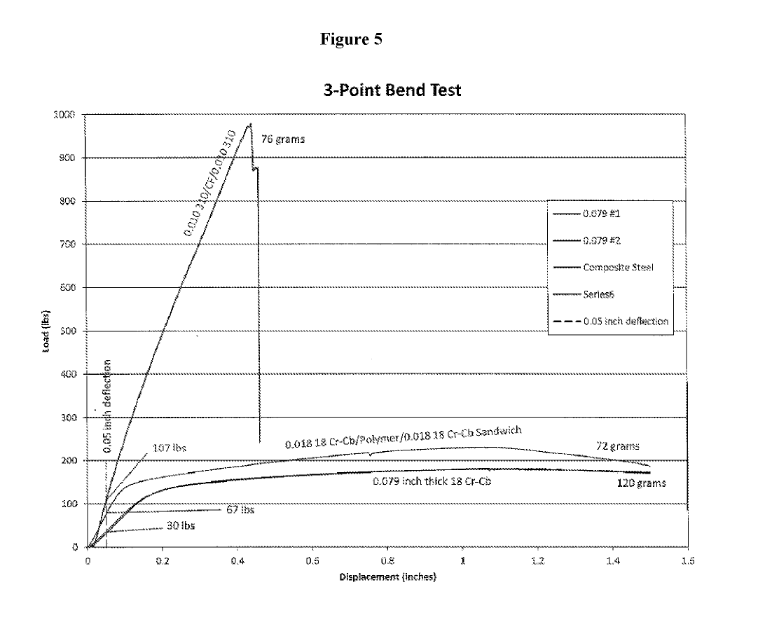

The composite steel sheet was able to handle higher loads than the mono-steel sheets as shown in FIG. 4. For instance, at 0.05 inches of deflection, the composite steel sheet had a load of about 67 lbs., while the 0.079-inch-thick mono-steel sheet had a load of about 30 lbs. and the 0.059-inch-thick mono-steel sheet had a load of about 15 lbs. The composite steel showed higher stiffness at lower weight.

### Example 3

A composite steel sheet having carbon fiber was then evaluated. The carbon fiber was pre-impregnated with a bonding resin. The type 310 steel sheets were positioned on each side of the carbon fiber and cured at 400 deg. F. in a hydraulic press with heated platens. The thickness of each steel sheet was about 0.010 inches and the composite weighed about 76 grams. The improved load carrying capability of the carbon fiber composite steel, compared to those in Example 2, is shown in FIG. 5. For instance, the carbon fiber composite steel was able to handle 107 lbs. at 0.05 inches of bending deflection.

What is claimed is:

1. A composite steel comprises at least two outer steel layers and at least one spacer separating said at least two outer steel layers from each other.

2. The composite steel of claim 1 further comprising adhesive applied between each outer steel layer and the spacer.

3. The composite steel of claim 1 wherein at least one of the two outer steel layers comprises stainless steel.

4. The composite steel of claim 1 wherein the spacer comprises a metal that is less dense than steel.

5. The composite steel of claim 4 wherein the spacer comprises either aluminum, magnesium, or alloys of aluminum or magnesium.

6. The composite steel of claim 1 wherein the spacer comprises polymers or resins.

7. The composite steel of claim 6 wherein the spacer further comprises carbon fiber, glass fiber, or Kevlar material.

8. A method of making a composite steel comprising the steps of interleaving at least two outer steel layers with at least one spacer such that said at least one spacer separates each of the outer steel layers.

9. The method of claim 8 further comprising the step of bonding said spacer to each of said outer steel layers.

10. The method of claim 9 wherein said bonding is accomplished by heating said composite steel.

11. A method of making a formed part comprising the steps of forming a part from the composite steel of claim 8.

12. The method of claim 11 further comprising the step of bonding said spacer to each of said outer steel layers during the forming process.

13. The method of claim 11 further comprising the step of bonding said spacer to each of said outer steel layers after said forming process in a subsequent step.

14. The method of claim 13 wherein said subsequent step is either a painting step or a heating step.
